(19) United States
(12) Patent Application Publication
(10) Pub. No.: US 2013/0077173 A1
(43) Pub. Date: Mar. 28, 2013

(54) DISPLAY SCREEN MASK STRUCTURE USING SHIELDING FRAME AND MANUFACTURING METHOD THEREOF

(71) Applicants: Rih-Yang WANG, Taichung city (TW); Po-Tang Wang, Taichung City (TW); Shu-Hui Chang, Taichung City (TW)

(72) Inventors: Rih-Yang WANG, Taichung city (TW); Po-Tang Wang, Taichung City (TW); Shu-Hui Chang, Taichung City (TW)

(21) Appl. No.: 13/354,378

(22) Filed: Jan. 20, 2012

(30) Foreign Application Priority Data
Sep. 22, 2011 (TW) 100134043

(51) Int. Cl. G02B 1/11; B32B 38/10; B29D 11/00

(52) U.S. Cl. 359/609; 264/1.9; 156/251; 156/267

(57) ABSTRACT

The present invention relates to a display screen mask structure using a shielding frame and a manufacturing method thereof. A combination of a shielding frame body and a plurality of substrate units, or a combination of a surface-printing outer frame portion and a surface-printing separated inner frame portion of a shielding frame body to be connectively overlapped on a single or multiple layers of light-transmitting thin film substrate, is overlapped on a self-light emitting display element of a photoelectric device panel. The light, scattered from the self-light emitting display element, is filtered and reflected by and concentratedly radiated from the outer frame portion and the separated inner frame portions of the shielding frame body, so that the light radiated from the self-light emitting display element of the photoelectric device panel is more concentratedly purified and has an enhanced color contrast of the dark tone.

### BACKGROUND OF THE INVENTION

1. Field of the Invention

The present invention relates to a display screen mask structure using a shielding frame and a manufacturing method thereof, and in particular relates to a related technical skill applied for photoelectric display devices.

2. Description of the Related Art

Evaporation methods are often utilized to manufacture filtering structures of conventional photoelectric device panels. The photoelectric device panel includes a self-light emitting display element having a thin film multilayer structure, a substrate plate disposed on one side of the self-light emitting display element, and a metallic-pattern molded shielding plate disposed on another side of the substrate plate.

In the film-forming manufacturing process of the evaporation method, the vaporization material is attachingly combined to the substrate plate through the metallic-pattern molded shielding plate, and thus the metallic-pattern molded shielding plate overlapped on the surface of the substrate plate can be utilized to shield the light. However, there still have some following problems of this conventional filtering structure occurred in the actual application.

Firstly, when the conventional displayer is radiated by an outdoor strong light, the intensity ratio of between the light being refracted from the display screen and the light being radiated on the display screen, 180Lux/40000×0.8Lux≈0.005625 [polarizer cross-section coefficient multiplied by the coefficient of vertical cross-section of polarizer reflecting the external strong light] presents that the contrast ratio of the display screen is very small, and the light transmitted intensity is only ⅕ left when further adding the conventional polarizer, and there has a large difference when comparing to the indoor visual acuity, 180 Lux/300Lux˜0.6. Moreover, when the display has an increased light intensity corresponding to that of the external strong light, the RGB colors of the displayer is easily fugitive and can only be sustained for about one to two years. Thus, the display result of this conventional filtering structure is worsen while being illuminated by the external strong light.

Secondly, although this filtering structure using for general displayers can have a better shielding effect, the mask having a large-size protruded structure is still required to be supported or foldably received. Thus, the usability of this conventional filtering structure is imperfect. For example, Taiwan Patent No. 1337238 discloses a general digital camera provided with a conventional foldable single mask.

Thirdly, if the antiglare film s additionally utilized in the conventional filtering structure, the total light transmittance rate is reduced by the antiglare film and no effect is presented when an outdoor sunlight directly radiates on the display screen. Thus, the light transmittance rate of this conventional filtering structure is low.

Fourthly, a larger metallic-pattern molded shielding plate is required when a larger panel is manufactured by the evaporation method. However, the large metallic-pattern molded shielding plate is centrally sank by the gravity thereof so that the accuracy of the film pattern overlapped on the surface of the substrate plate is decreased, thus limiting the dimensional workability.

Fifthly, due to a high thermal expansion rate of the metallic-pattern molded shielding plate, the pattern of the metallic-pattern molded shielding plate is tended to be shifted when the evaporation method is applied, thus increasing the processing difficulty.

### BRIEF SUMMARY OF THE INVENTION

In view of the light-filtering structure of the conventional photoelectric device panel having a limited dimensional workability and high difficulty in manufacturing process, the present invention provide a display screen mask structure and a manufacturing method thereof to overcome these inconveniences.

The purpose of the present invention is to provide a display screen mask structure and a manufacturing method thereof. A combination of a shielding frame body and a plurality of substrate units, or a combination of a surface-printing outer frame portion and a surface-printing separated inner frame portion of a shielding frame body to be connectively overlapped on a single or multiple layers of light-transmitting thin film substrate, is overlapped on a self-light emitting display element of a photoelectric device panel. The light, scattered from the self-light emitting display element, is filtered and reflected by and concentratedly radiated from the outer frame portion and the separated inner frame portions of the shielding frame body, so that the light radiated from the self-light emitting display element of the photoelectric device panel is more concentratedly purified and has an enhanced color contrast of the dark tone. Further, the present invention has a simple configuration capable of applying to different sizes of soft and rigid panels of photoelectric devices and in varied fields, thereby reducing the total manufacturing cost and simplifying the manufacturing process.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a perspective schematic view showing a shielding frame body of the present invention;

FIG. 2 is a schematic view showing a separated inner frame portion of a shielding frame body arranged in the mode that an inclined plane of which the surround inwardly inclines of the present invention;

FIG. 3 is a perspective schematic view showing a combination status of the present invention;

FIG. 4 is a partially enlarged top schematic view of the present invention;

FIG. 5 is a reference view showing a first working status of the present invention;

FIG. 6 is a reference view showing a second working status of the present invention;

FIG. 7 is a flow chart of a manufacturing process of the present invention;

FIG. 8 is a perspective reference view showing a combination status of a first embodiment of the present invention;

FIG. 9 is a flow chart of a manufacturing process of the first embodiment of the present invention;

FIG. 10 is a perspective reference view showing a combination status of a second embodiment of the present invention;

FIG. 11 is a laterally partially-sectional reference view of a third embodiment of the present invention; and

FIG. 12 is a laterally partially-sectional reference view of a fourth embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

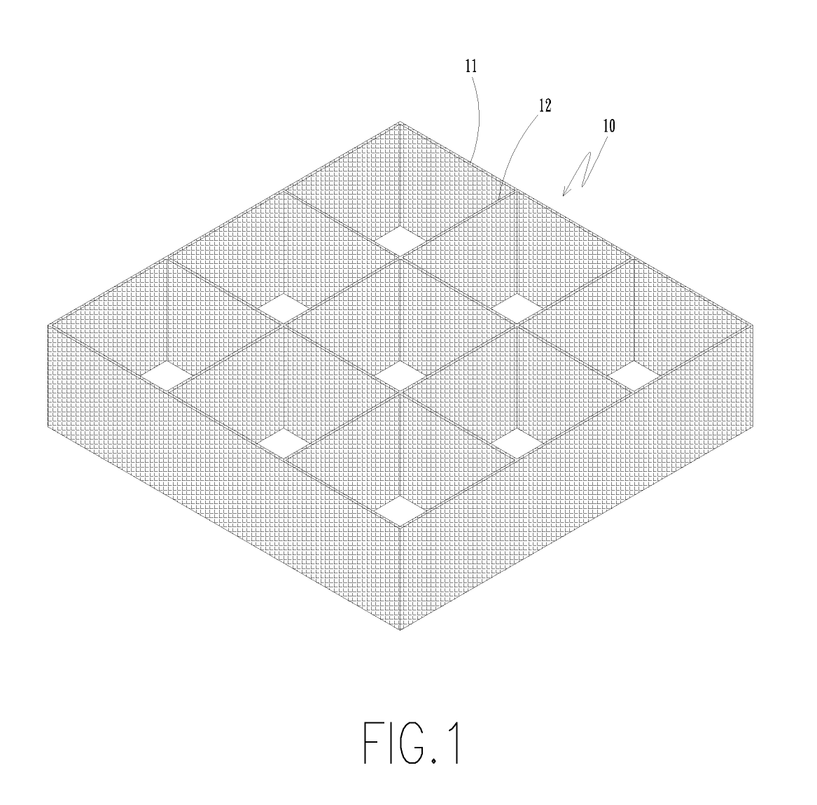

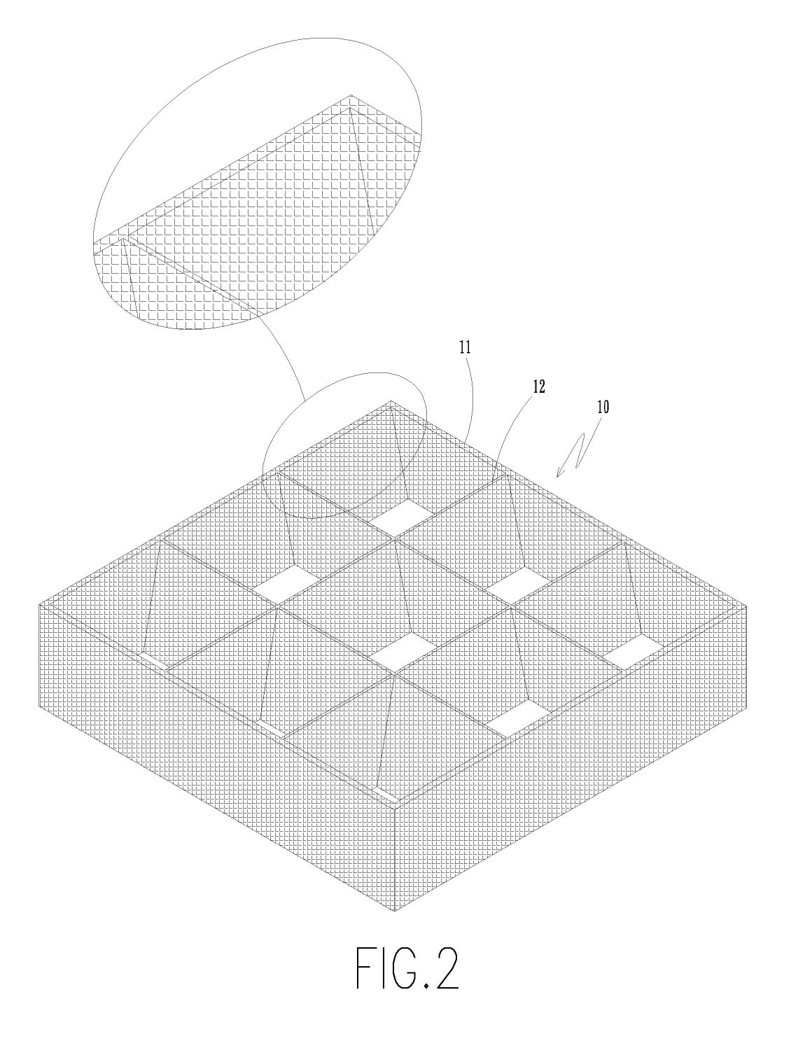

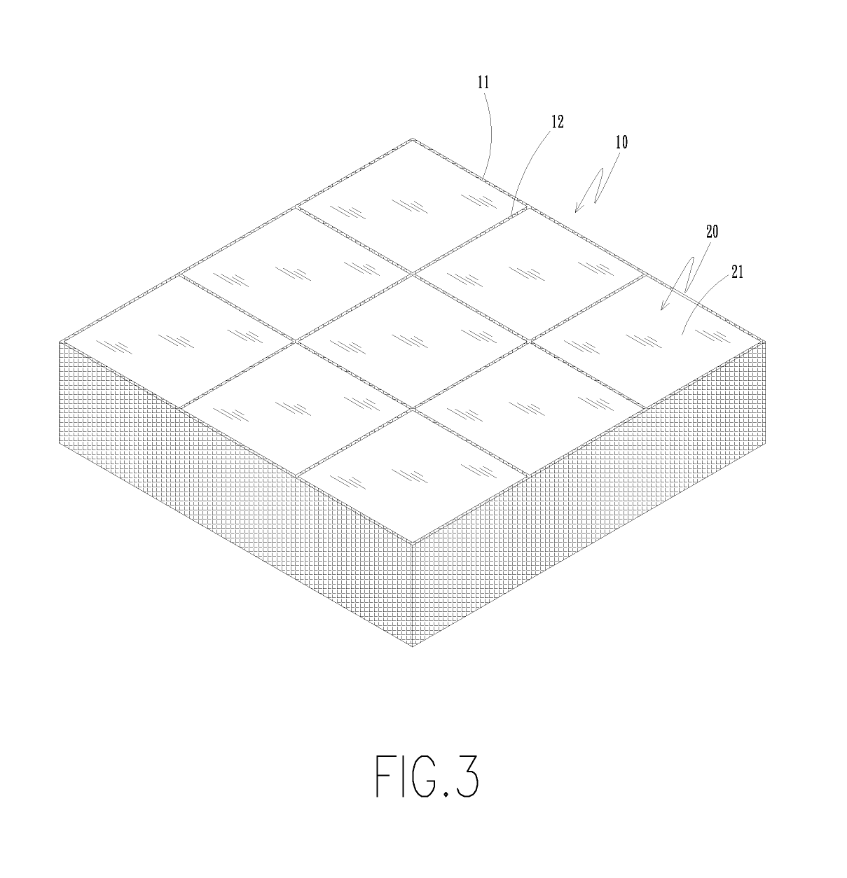

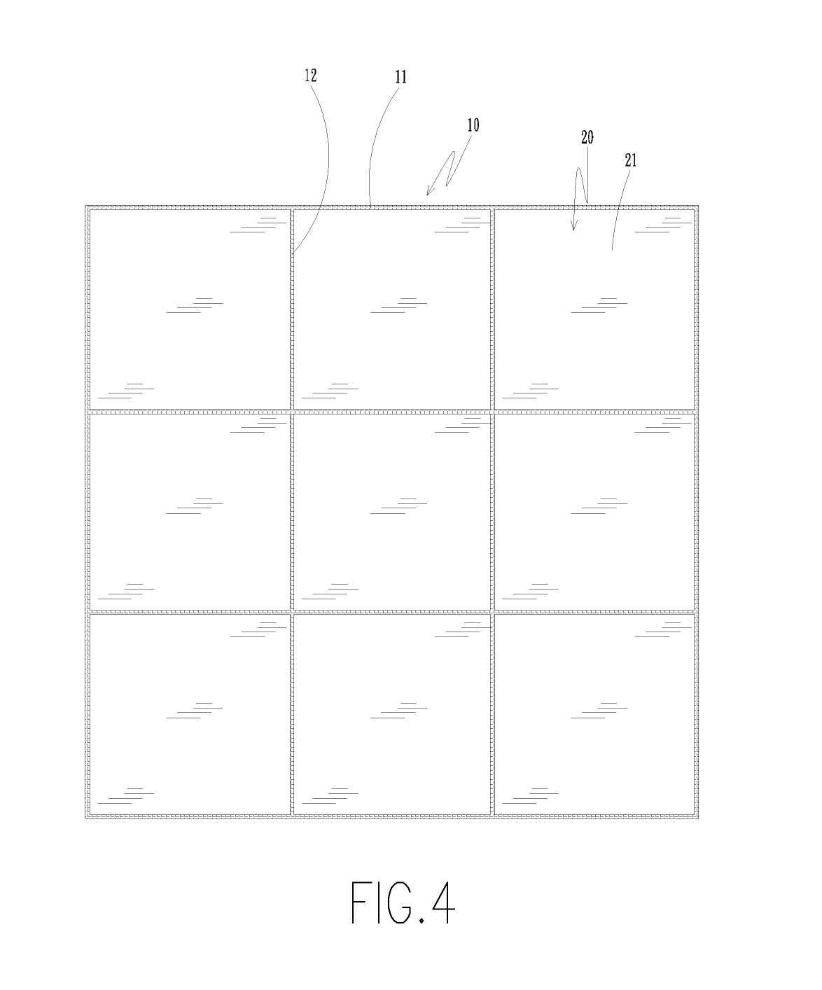

Referring to FIGS. 1, 2, 3 and 4, FIG. 1 is a perspective schematic view showing a shielding frame body of a display screen mask structure using a shielding frame of the present invention, FIG. 2 is a schematic view showing a separated inner frame portion of a shielding frame body arranged in the mode that an inclined plane of which the surround inwardly inclines, FIG. 3 is a perspective schematic view showing a combination status, and FIG. 4 is a top schematic view of FIG. 3. The display screen mask structure using the shielding frame of the present invention comprises a shielding frame body 10 and a plurality of substrate units 20.

The shielding frame body 10 comprises an outer frame portion 11 and a plurality of separated inner frame portions 12 laterally and longitudinally arranged in the outer frame portion 11 respectively. In other embodiments, the separated inner frame portions 12 can be laterally arranged in the outer frame portion 11 (not shown in FIGs.). The shielding frame body 10 is made of a thin metallic material. The outer frame portion 11 and the separated inner frame portions 12 of the shielding frame body 10 are arranged in square, and the separated inner frame portions 12 of the shielding frame body 10 is arranged in the mode that an inclined plane of which the surround inwardly inclines. The shielding frame body 10 includes a bottom side disposed with an adhesive layer. A metallic light-transmitting thin film (not shown in FIG.s) is capable of being disposed on a surface of the shielding frame body 10, and at least two shielding frame bodies 10 can be laminated to each other.

Each of the substrate units 20 comprises a light-transmitting filling body 21 being fully filled and accommodated in between the outer frame portion 11 and the separated inner frame portions 12 of the shielding frame body 10. The light-transmitting filling body 21 of the substrate unit 20 is made of high light-transmitting resin material, polymethyl methacrylate (acrylic) material, or plastic material such as polyethylene terephthalate (PET). The light-transmitting filling body 21 of the substrate unit 20 is provided with yellow light-transmitting feature.

The above-described structures, the shielding frame body 10 and the substrate units 20, are combined to form the display screen mask structure using the shielding frame of the present invention.

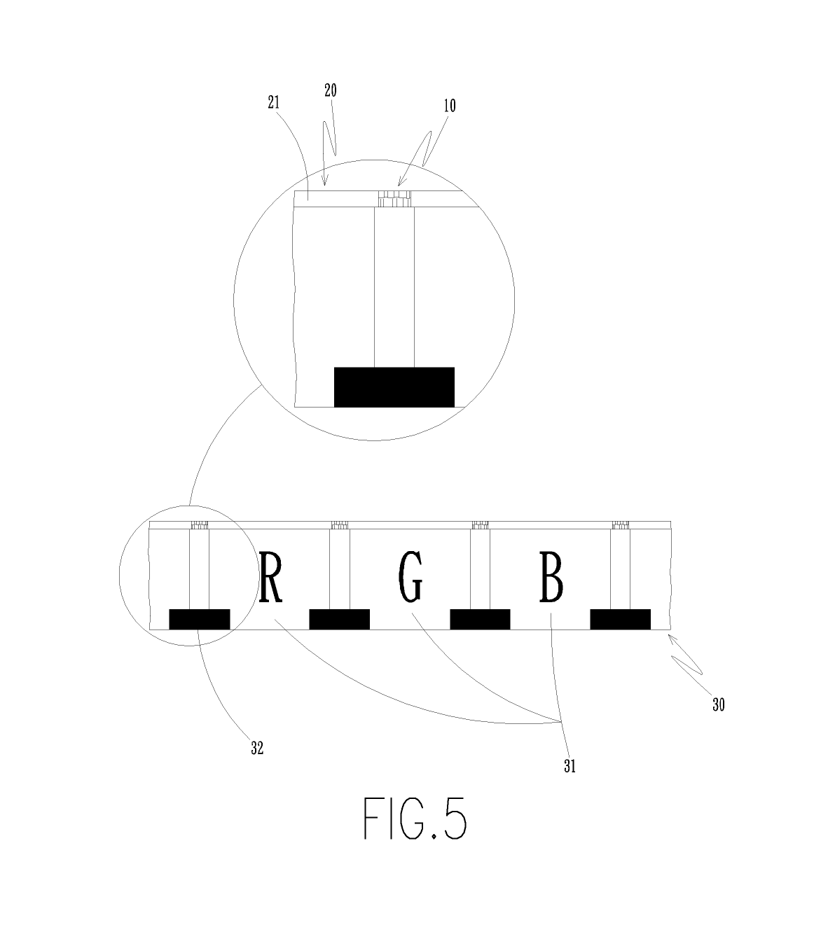

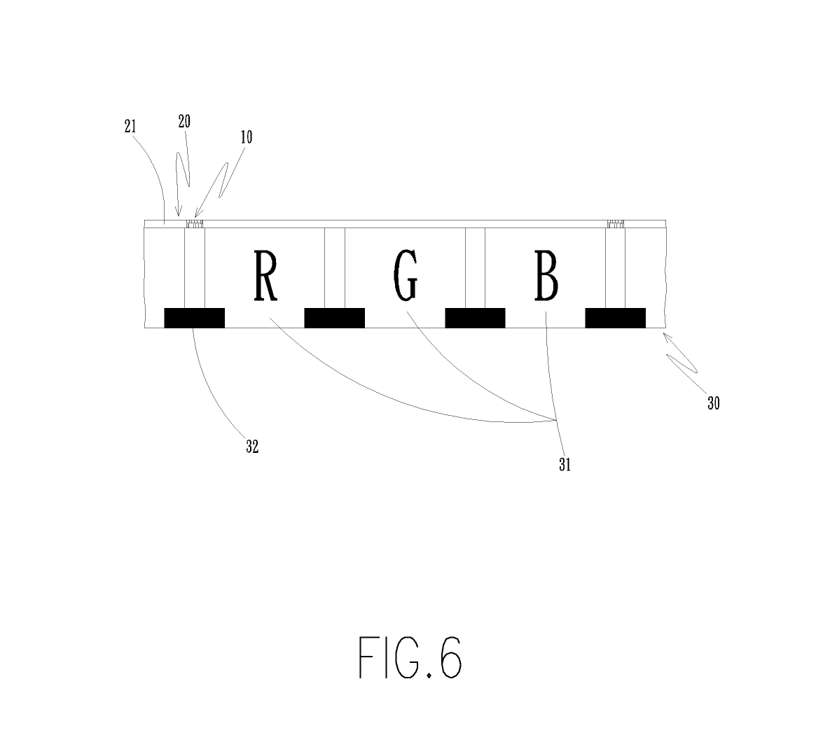

Referring to FIGS. 5 and 6, FIGS. 5 and 6 are reference views, showing a first working status and a second working status of the display screen mask structure using the shielding frame of the present invention, respectively. The light-transmitting filling body 21 of the substrate units 20 is fully filled and accommodated in between the outer frame portion 11 and the separated inner frame portions 12 of the shielding frame body 10. The combined structure of the shielding frame body 10 and the substrate units 20 is overlapped on a self-light emitting display element 30 of a photoelectric device panel, wherein R.G.B and Y, or R+G+B and R+G+B+Y light source display modules 31 of the self-light emitting display element 30 are corresponding to the light-transmitting filling body 21 of the substrate unit 20, and the black matrixes 32 of the self-light emitting display element 30 are corresponding to the outer frame portion 11 and the separated inner frame portions 12 of the shielding frame body 10. The light, scattered from the self-light emitting display element, is filtered and reflected by and concentratedly radiated from the outer frame portion 11 and the separated inner frame portions 12 of the shielding frame body 10. Thus, the light radiated from the self-light emitting display element 30 of the photoelectric device panel is more concentratedly purified and has an enhanced color contrast of the dark tone, and the display screen mask structure using the shielding frame of the present invention has a simple configuration capable of applying to different sizes of photoelectric device panels and in varied fields, reducing the total manufacturing cost, and simplifying the manufacturing process.

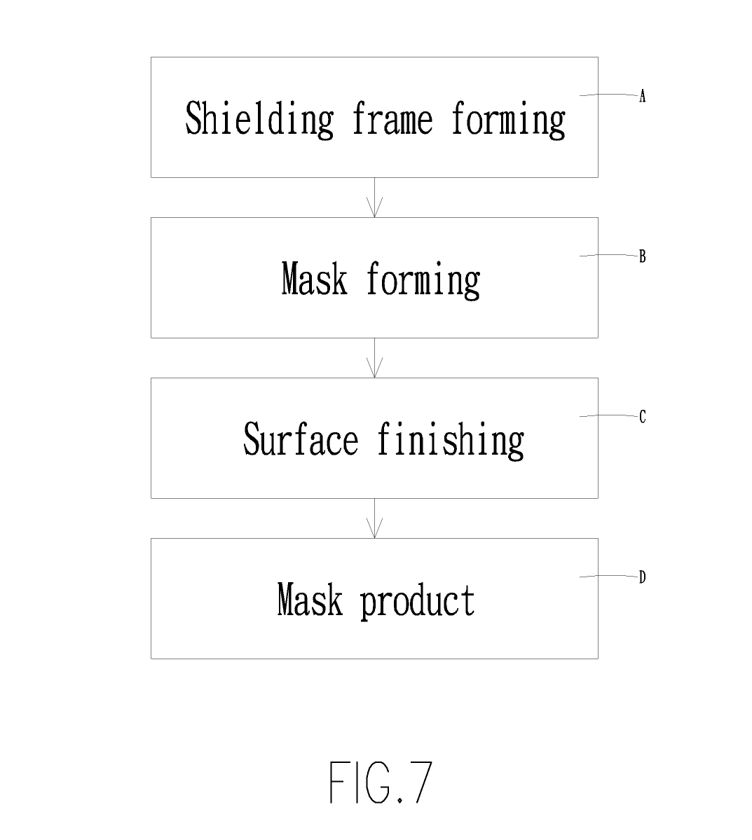

FIG. 7 is a flow chart of a manufacturing process of the display screen mask structure using the shielding frame of the present invention. The manufacturing procedure of the display screen mask structure using the shielding frame comprises the following steps as below:

(A) repeatedly performing mirco-stamping machining on a high ductility metallic substrate comprising aluminum to form a shielding frame body;

(B) fully filling and accommodating a light-transmitting filling body of a substrate unit, comprising high light-transmitting re÷sin material, polymethyl methacrylate (acrylic) material, or plastic material, in between an outer frame portion and a separated inner frame portions of the shielding frame body in a mask forming step;

(C) grinding a surface formed by a combining structure of the shielding frame body and the substrate unit into a smooth and clean surface or a mist surface in a surface finishing step; and

(D) forming the combining structure of the shielding frame body 10 and the substrate unit processed in the surface finishing step into a thin film mask product of large-area sheet material.

With the manufacturing procedure of the display screen mask structure using the shielding frame above, the light radiated from the self-light emitting display element 30 of the photoelectric device panel can be more concentrated.

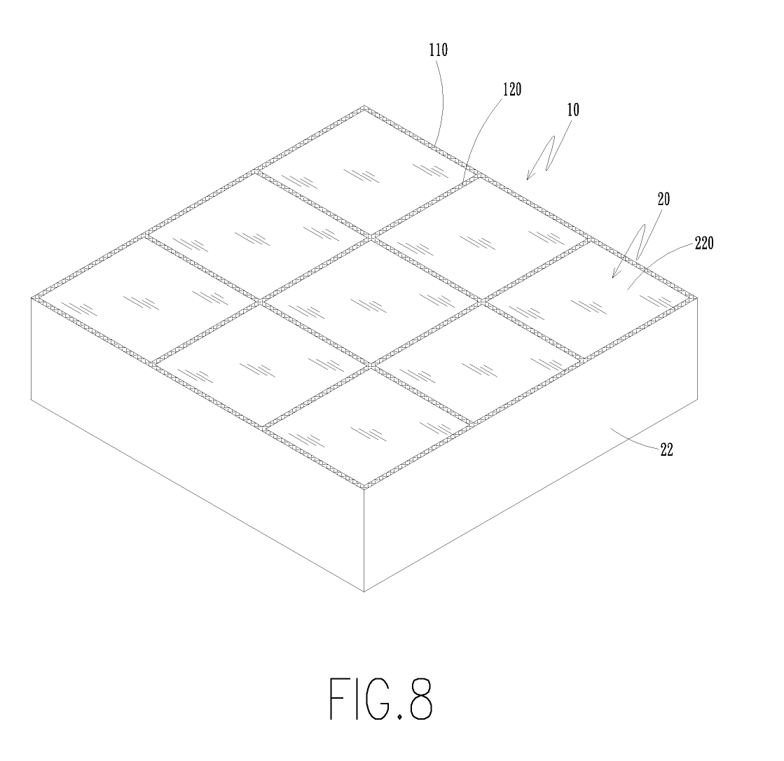

Referring to FIG. 8, FIG. 8 is a perspective reference view showing a combination status of a display screen mask structure using a shielding frame of a first embodiment of the present invention. The display screen mask structure comprises a plurality of substrate units 10 and a plurality of combining units 20. The shielding frame body 10 comprises a surface-printing outer frame portion 110 and a plurality of surface-printing separated inner frame portions 120 laterally and longitudinally or only laterally arranged in the surface-printing outer frame portion 110, respectively.

The substrate unit 20 comprises a light-transmitting thin film substrate 22, or the substrate unit 20 at least comprises an optical thin layer of one-fourth wavelength formed as a top layer thereof (not shown in FIGs.). The light-transmitting thin film substrate 22 comprises a surface portion 220 connectively overlapped by the surface-printing outer frame portion 110 and the surface-printing separated inner frame portion 120 of the shielding frame body 10. The light-transmitting thin film substrate 22 of the substrate unit 20 is made of high light-transmitting resin material, polymethyl methacrylate (acrylic) material, or soft/rigid plastic material such as polyethylene terephthalate (PET). The combined structure of the shielding frame body 10 and the substrate units 20 is overlapped on a self-light emitting display element 30 of a photoelectric device panel, wherein the light-emitting unit R.G.B light source display modules 31 of the self-light emitting display element 30 are corresponding to the light-transmitting thin film substrate 22 of the substrate unit 20, and the black matrixes 32 of the self-light emitting display element 30 are corresponding to the surface-printing outer frame portion 110 and the surface-printing separated inner frame portion 120 of the shielding frame body 10. The light, scattered from the self-light emitting display element, is filtered and reflected by and concentratedly radiated from the surface-printing outer frame portion 110 and the surface-printing separated inner frame portion 120 of the shielding frame body 10. Thus, the light radiated from the self-light emitting display element 30 of the photoelectric device panel is more concentratedly purified and has an enhanced color contrast of the dark tone. Further, the structure of the light-transmitting thin film substrate 22 of the substrate unit 20 can be varied in accordance with the shielding size of the self-light emitting display element 30 of the photoelectric device panel, and the shielding frame body 10 and the substrate units 20 can be combined to each other by printing, thereby reducing the total manufacturing cost, increasing the application field, and simplifying the manufacturing process.

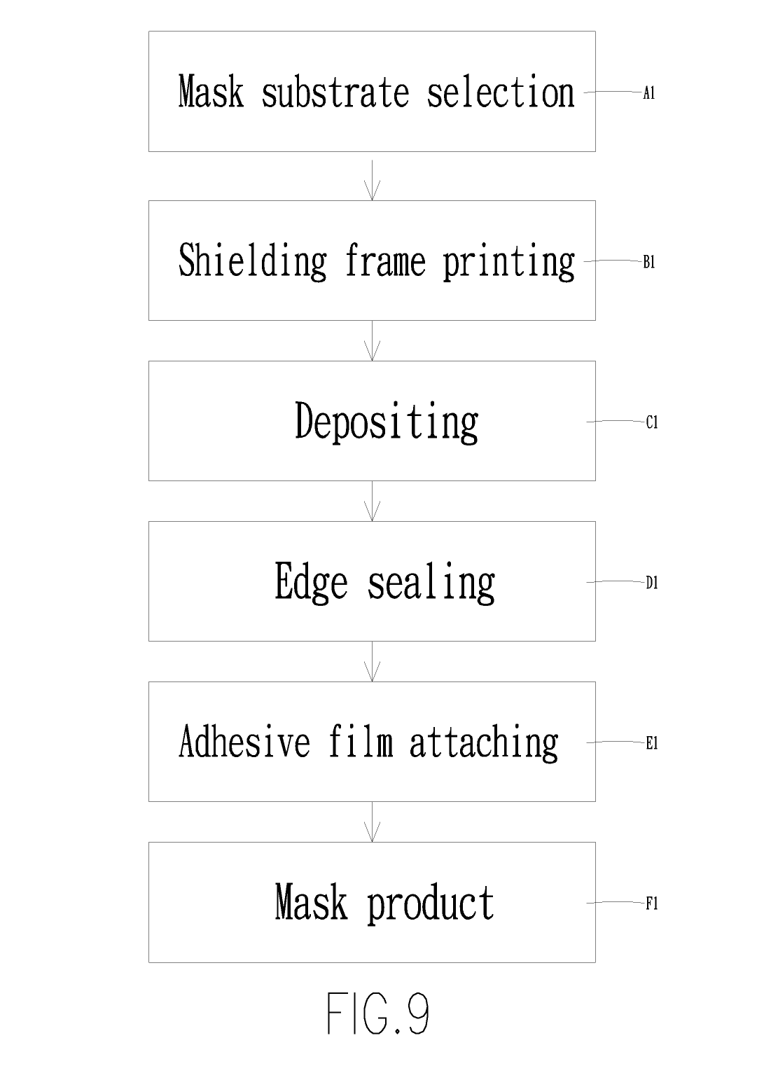

FIG. 9 is a flow chart of a manufacturing process of the first embodiment of the present invention. The manufacturing procedure of the display screen mask structure using the shielding frame comprises the following steps as below:

(A1) selecting a light-transmitting thin film substrate of a substrate unit from high light-transmitting resin material, polymethyl methacrylate (acrylic) material, or soft/rigid plastic material in a mask substrate selection step;

(B1) overlapping a surface-printing outer frame portion and a surface-printing separated inner frame portion of a shielding frame body on the light-transmitting thin film substrate of the substrate unit by printing in a shielding frame printing step;

(C1) depositing the light-transmitting thin film substrate of the substrate unit processed in the shielding frame printing step in a Newton ring eliminator to a desired thickness in a depositing step;

(D1) removing a sealed edge from or synchronically cutting and edge-sealing the light-transmitting thin film substrate of the substrate unit in an edge-sealing step;

(E1) attaching an adhesive film on the light-transmitting thin film substrate of the substrate unit processed in the edge-sealing step in an adhesive film attaching step;

(F1) forming the light-transmitting thin film substrate of the substrate unit processed in the adhesive film attaching step into a thin film mask product of large-area sheet material in a mask product forming step; and

(G1) selectively providing the substrate unit with at least an optical thin layer of one-fourth wavelength formed as a top layer thereof (not shown in FIGs.).

With the manufacturing procedure of the display screen mask structure overlapped on the self-light emitting display element 30 of the photoelectric device panel, the light radiated from the self-light emitting display element 30 of the photoelectric device panel can be effectively shielded, so that the light leakage and diffusion can be prevented and the color contrast of the dark tone of the light radiated therefrom can be enhanced.

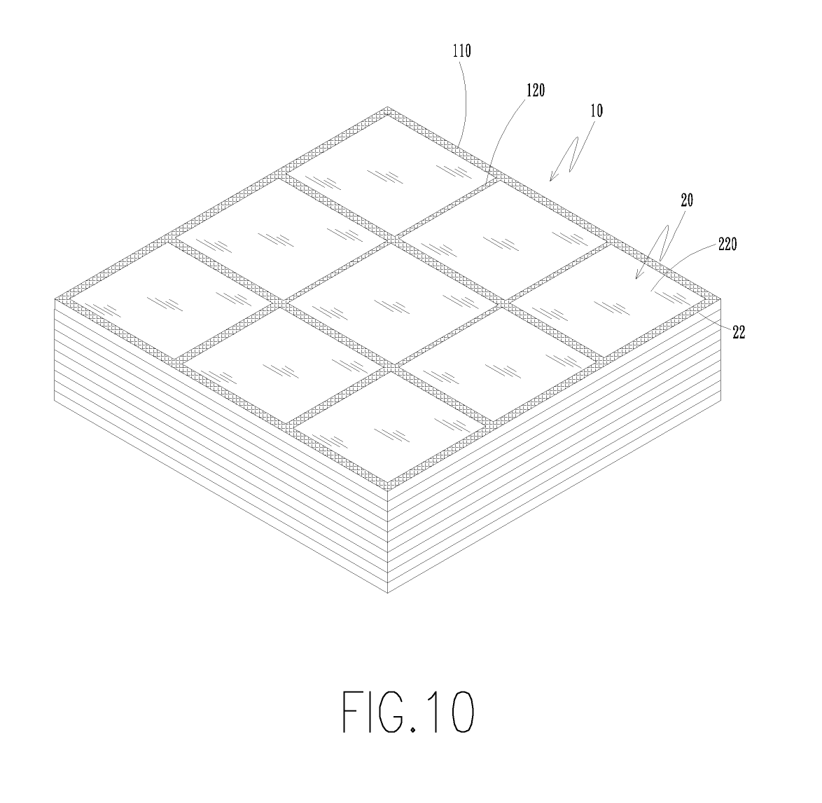

FIG. 10 is a perspective reference view showing a combination status of a display screen mask structure using a shielding frame of a second embodiment of the present invention, substantially having the same structure as that in FIGS. 5 and 6. The surface-printing outer frame portion 110 and the surface-printing separated inner frame portion 120 of the shielding frame body 10 are overlapped on the surface portion 220 of the light-transmitting thin film substrate 22 of the substrate unit 20. The light-transmitting thin film substrates 22 of the at least two substrate units 20 are laminated, and the surface-printing outer frame portion 110 and the surface-printing separated inner frame portion 120 of the shielding frame body 10 disposed on the surfaces of the light-transmitting thin film substrates 22 of each substrate unit 20 are relatively disposed. The light-transmitting thin film substrates 22 of the laminated substrate units 20 are overlapped on the self-light emitting display element 30 of the photoelectric device panel, and the light radiated from the self-light emitting display element 30 of the photoelectric device panel can be effectively shielded by the surface-printing outer frame portion 110 and the surface-printing separated inner frame portion 120 of the shielding frame body 10. Thus, the light radiated from the self-light emitting display element 30 of the photoelectric device panel is more concentratedly purified and has an enhanced color contrast of the dark tone, and the display screen mask structure using the shielding frame of the present invention has a simple configuration capable of applying to different sizes of photoelectric device panels and in varied fields, reducing the total manufacturing cost, and simplifying the manufacturing process.

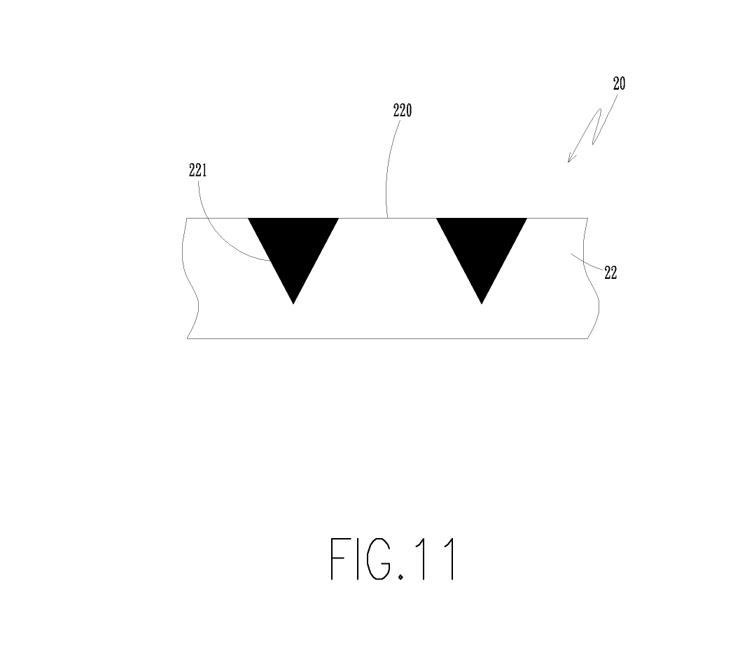

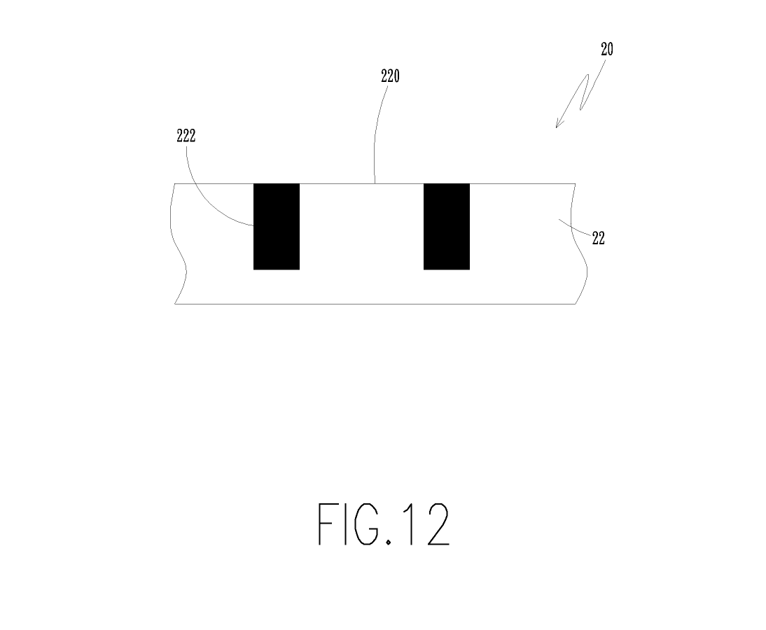

Referring to FIGS. 11 and 12, FIG. 11 is a laterally partially-sectional reference view a display screen mask structure using a shielding frame of a third embodiment of the present invention, and FIG. 12 is a laterally partially-sectional reference view the display screen mask structure using the shielding frame of the fourth embodiment of the present invention, substantially having the same structure as that in FIGS. 1, 2, 3 and 4. Particularly, a pattern of half-depth cutting channels 221 or slotted channels 222, formed on the surface portion 220 of the light-transmitting thin film substrate 22 of the substrate unit 20 by laser machining process, are filled with a black filling agent therein. On the other side of the surface portion 220 of the light-transmitting thin film substrate 22 of the substrate unit 20, a layer of optical film, antiglare film or a micro-convex film (not shown in FIGs.) having a thickness at least equal to one-fourth optical wavelength, thereby increasing the practicability of the present invention.

The advantages of the display screen mask structure using the shielding frame of the present invention are described as follows.

First of all, the film mask, combined by the shielding frame body and the substrate units and overlapped on a self-light emitting display element of the photoelectric device panel, can be dimensionally extended and expanded in accordance with the requirements of the photoelectric device panel at large or small sizes, so that the scope of application of the present application covers a wild range.

Further, by repeatedly performing mirco-stamping machining on the high ductility metallic substrate to form the shielding frame body, filling the light-transmitting filling body of a substrate unit in the shielding frame body, or overlapping the surface-printing outer frame portion and the surface-printing separated inner frame portion of the shielding frame body on the light-transmitting thin film substrate of the substrate unit by surface printing, it is understood that the manufacturing process of the configuration structure of the present invention can be simply performed and achieved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display screen mask structure using a shielding frame, comprising:
a shielding frame body comprising an outer frame portion and a plurality of separated inner frame portions disposed in the outer frame portion.

2. The display screen mask structure using the shielding frame as claimed in claim 1, wherein the separated inner frame portions are laterally and longitudinally arranged, respectively.

3. The display screen mask structure using the shielding frame as claimed in claim 1, wherein the separated inner frame portions are laterally arranged.

4. The display screen mask structure using the shielding frame as claimed in claim 1, wherein the shielding frame body is made of a thin metallic material.

5. The display screen mask structure using the shielding frame as claimed in claim 1, wherein the outer frame portion and the separated inner frame portion of the shielding frame body are arranged in square.

6. The display screen mask structure using the shielding frame as claimed in claim 1, wherein the separated inner frame portion of the shielding frame body is arranged in circular.

7. The display screen mask structure using the shielding frame as claimed in claim 1, wherein the separated inner frame portion of the shielding frame body is arranged in the mode that an inclined plane of which the surround inwardly inclines.

8. The display screen mask structure using the shielding frame as claimed in claim 1, wherein the shielding frame body includes a bottom side disposed with an adhesive layer.

9. The display screen mask structure using the shielding frame as claimed in claim 1 further comprising a light-transmitting filling body providing yellow light-transmitting feature.

10. The display screen mask structure using the shielding frame as claimed in claim 1 further comprising at least two shielding frame bodies laminated to each other.

11. A display screen mask structure using a shielding frame, comprising:
a shielding frame body comprising an outer frame portion and a plurality of separated inner frame portions disposed in the outer frame portion; and
a plurality of substrate units, each of which comprising a light-transmitting filling body being fully filled and accommodated in between the outer frame portion and the separated inner frame portions of the shielding frame body.

12. The display screen mask structure using the shielding frame as claimed in claim 11, wherein the separated inner frame portions are laterally and longitudinally arranged, respectively.

13. The display screen mask structure using the shielding frame as claimed in claim 11, wherein the separated inner frame portions are laterally arranged.

14. The display screen mask structure using the shielding frame as claimed in claim 11, wherein the shielding frame body is made of a thin metallic material.

15. The display screen mask structure using the shielding frame as claimed in claim 11, wherein the light-transmitting filling body of the substrate unit is made of high light-transmitting resin material.

16. The display screen mask structure using the shielding frame as claimed in claim 11, wherein the light-transmitting filling body of the substrate unit is made of polymethyl methacrylate or acrylic material.

17. The display screen mask structure using the shielding frame as claimed in claim 11, wherein the light-transmitting filling body of the substrate unit is made of plastic material.

18. The display screen mask structure using the shielding frame as claimed in claim 11, wherein the outer frame portion and the separated inner frame portion of the shielding frame body are arranged in square.

19. The display screen mask structure using the shielding frame as claimed in claim 11, wherein the separated inner frame portion of the shielding frame body is arranged in circular.

20. The display screen mask structure using the shielding frame as claimed in claim 11, wherein the shielding frame body and the substrate unit are combined to provide a surface disposed with an optical film having a thickness at least equal to one-fourth optical wavelength.

21. The display screen mask structure using the shielding frame as claimed in claim 11, wherein the shielding frame body and the substrate unit are combined to provide a surface disposed with an antiglare film or a micro-convex film.

22. The display screen mask structure using the shielding frame as claimed in claim 11, wherein the shielding frame body includes a bottom side disposed with an adhesive layer.

23. The display screen mask structure using the shielding frame as claimed in claim 11, wherein the light-transmitting filling body provides yellow light-transmitting feature.

24. The display screen mask structure using the shielding frame as claimed in claim 11, wherein the shielding frame body includes a surface disposed with a metallic light-transmitting film.

25. A method for manufacturing a display screen mask structure using a shielding frame, comprising:
(A) repeatedly performing mirco-stamping machining on a high ductility metallic substrate comprising aluminum to form a shielding frame body in a shielding frame forming step;
(B) fully filling and accommodating a light-transmitting filling body of a substrate unit, comprising high light-transmitting resin material, polymethyl methacrylate or acrylic material, or plastic material, in between an outer frame portion and a separated inner frame portions of the shielding frame body in a mask forming step;
(C) grinding a surface formed by a combining structure of the shielding frame body and the substrate unit into a smooth and clean surface or a mist surface in a surface finishing step; and
(D) forming the combining structure of the shielding frame body and the substrate unit processed in the surface finishing step into a thin film mask product of large-area sheet material.

26. A display screen mask structure using a shielding frame, comprising:
a shielding frame body comprising a surface-printing outer frame portion and a plurality of surface-printing separated inner frame portions laterally and longitudinally or only laterally arranged in the surface-printing outer frame portion; and
a substrate unit comprising a light-transmitting thin film substrate having a surface portion connectively overlapped by the surface-printing outer frame portion and the surface-printing separated inner frame portion of the shielding frame body.

27. The display screen mask structure using the shielding frame as claimed in claim 26, wherein the light-transmitting thin film substrate of the substrate unit is made of high light-transmitting resin material.

28. The display screen mask structure using the shielding frame as claimed in claim 26, wherein the light-transmitting thin film substrate of the substrate unit is made of polymethyl methacrylate or acrylic material.

29. The display screen mask structure using the shielding frame as claimed in claim 26, wherein the light-transmitting thin film substrate of the substrate unit is made of rigid plastic material.

30. The display screen mask structure using the shielding frame as claimed in claim 26, wherein the light-transmitting thin film substrate of the substrate unit is made of soft plastic material.

31. The display screen mask structure using the shielding frame as claimed in claim 26, wherein the substrate unit comprises at least two light-transmitting thin film substrates laminated to each other, and the shielding frame body is correspondingly disposed on a surface of the light-transmitting thin film substrate of each of the substrate units.

32. A method for manufacturing a display screen mask structure using a shielding frame, comprising:
(A1) selecting a light-transmitting thin film substrate of a substrate unit from high light-transmitting resin material, polymethyl methacrylate or acrylic material, or soft/rigid plastic material in a mask substrate selection step;
(B1) overlapping a surface-printing outer frame portion and a surface-printing separated inner frame portion of a shielding frame body on the light-transmitting thin film substrate of the substrate unit by printing in a shielding frame printing step;
(C1) depositing the light-transmitting thin film substrate of the substrate unit processed in the shielding frame printing step in a Newton ring eliminator to a desired thickness in a depositing step;
(D1) removing a sealed edge from or synchronically cutting and edge-sealing the light-transmitting thin film substrate of the substrate unit in an edge-sealing step;
(E1) attaching an adhesive film on the light-transmitting thin film substrate of the substrate unit processed in the edge-sealing step in an adhesive film attaching step; and
(F1) forming the light-transmitting thin film substrate of the substrate unit processed in the adhesive film attaching step into a thin film mask product of large-area sheet material in a mask product forming step.

33. A method for manufacturing a display screen mask structure using a shielding frame, comprising:
providing (A1) a substrate unit comprising a light-transmitting thin film substrate formed with a surface portion;
forming a pattern of a half-depth cutting channel or a slotted channel on the surface portion of the light-transmitting thin film substrate of the substrate unit by laser machining; and
filling a black filling agent in the half-depth cutting channel or the slotted channel formed on the surface portion of the light-transmitting thin film substrate of the substrate unit.
